(19) United States
(12) Patent Application Publication
(10) Pub. No.: US 2011/0095244 A1
(43) Pub. Date: Apr. 28, 2011

(54) POLYMER COMPOSITE WITH INTUMESCENT GRAPHENE

(75) Inventors: Suh Joon Han, Belle Mead, NJ (US); Michael S. Paquette, Midland, MI (US); Robert C. Cieslinski, Midland, MI (US)

(73) Assignee: Dow Global Technologies, Inc., Midland, MI (US)

(21) Appl. No.: 12/999,660

(22) PCT Filed: Jun. 29, 2009
(86) PCT No.: PCT/US09/49020

§ 371 Date: Dec. 17, 2010

Related U.S. Application Data
(60) Provisional application No. 61/076,961, filed on Jun. 30, 2008.

(51) Int. Cl. C09K 21/14

(52) U.S. Cl. 252/601; 977/700

(57) ABSTRACT

The polymer composition is a flame retardant composition comprising an organic polymer and nanographene. Suitable organic polymers include polymers such as polyolefins and polyvinyl chloride. Preferably, the nanographene should have an aspect ratio greater than equal to about 1000:1, should have a surface area greater than or equal to about 100 m²/gram nitrogen surface absorption area, and be expanded.

This invention relates to polymer composites. Specifically, the invention relates to flame retardant polymer composites.

For many polymer composite applications, flame retardant performance remains a critical issue. Especially when coupled with properties such as physical properties, thermal conductivity, and electrical conductivity, flame retardant is often elusive. Flame retardant performance is particularly critical in applications such as flooring, building and construction materials, piping, wires, cables, and conveying surfaces including conveyer belts for mining. Thermal and electrical conductivity are critical in applications demanding electromagnetic or radio-frequency shielding.

In flame retardant technology, there are three basic approaches widely applied in wire and cables: (1) gas phase flame retardant; (2) endothermic flame retardant; and (3) char-forming flame retardant.

Gas phase flame retardant reduces heat of combustion (ΔH_{c}), resulting in incomplete combustion by quenching radicals in processes. One of disadvantages is a potential of environmental issues of the gas phase flame retardant (e.g. halogen or phosphate compound).

Endothermic flame retardant extracts heat from the flame. It functions in gas phase and condensed phase via endothermic release of H₂O so that polymer system cooled and gas phase diluted. However, it requires a high loading (e.g. 30˜50 weight %), which results in negative impact on mechanical properties. It is typically from metal hydrates such as alumina trihydrate (ATH) and magnesium hydroxide.

Char-forming flame retardant operates in condensed phase, providing thermal insulation for underlying polymer and mass transport barriers, and also preventing or delaying escaping of fuel into the gas phase. It also requires a high loading (20˜50 weight %), which results in negative impact on mechanical properties of the polymer system.

As such, there is a need to (1) increase the oxygen index of flame retardant compositions with lower filler levels, (2) provide compositions with improved self-extinguishing behavior as demonstrated by the formation of homogeneous intumescent chars in UL 94 horizontal burning test, and (3) reduce average heat release rate as measured by a Cone Calorimeter test. There is also a need that the flame retardants added comprising the polymer composite (1) be non-toxic, (2) have no heavy metals, (3) be halogen-free, (4) be insoluble in water and other solvents, (5) have improved smoke and toxic gas liberation when exposed to heat sources, and (6) work synergistically with gas phase and endothermic flame retardants.

The polymer composition of the present invention comprises an organic polymer and nanographene.

Suitable organic polymers include polymers such as polyolefins and polyvinyl chloride. Suitable polyolefin polymers include ethylene polymers, propylene polymers, and blends thereof.

Ethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene. The polyethylene can also be a copolymer of ethylene and an unsaturated ester such as a vinyl ester (e.g., vinyl acetate or an acrylic or methacrylic acid ester), a copolymer of ethylene and an unsaturated acid such as acrylic acid, or a copolymer of ethylene and a vinyl silane (e.g., vinyltrimethoxysilane and vinyltriethoxysilane).

The polyethylene can be homogeneous or heterogeneous. The homogeneous polyethylenes usually have a polydispersity (Mw/Mn) in the range of 1.5 to 3.5 and an essentially uniform comonomer distribution, and are characterized by a single and relatively low melting point as measured by a differential scanning calorimeter. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.960 gram per cubic centimeter, and preferably have a density in the range of 0.870 to 0.955 gram per cubic centimeter. They also can have a melt index in the range of 0.1 to 50 grams per 10 minutes. If the polyethylene is a homopolymer, its melt index is preferably in the range of 0.75 to 3 grams per 10 minutes. Melt index is determined under ASTM D-1238, Condition E and measured at 190 degree C. and 2160 grams.

Low- or high-pressure processes can produce the polyethylenes. They can be produced in gas phase processes or in liquid phase processes (i.e., solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degree C. In the stirred autoclave, the pressure is in the range of 10,000 to 30,000 psi and the temperature is in the range of 175 to 250 degree C.

Copolymers comprised of ethylene and unsaturated esters or acids are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 5 to 50 percent by weight based on the weight of the copolymer, and is preferably in the range of 15 to 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Examples of the unsaturated acids include acrylic acids or maleic acids.

The melt index of the ethylene/unsaturated ester copolymers or ethylene/unsaturated acid copolymers can be in the range of 0.5 to 50 grams per 10 minutes, and is preferably in the range of 2 to 25 grams per 10 minutes.

Copolymers of ethylene and vinyl silanes may also be used. Examples of suitable silanes are vinyltrimethoxysilane and vinyltriethoxysilane. Such polymers are typically made using a high-pressure process. Use of such ethylene vinylsilane copolymers is desirable when a moisture crosslinkable composition is desired. Optionally, a moisture crosslinkable composition can be obtained by using a polyethylene grafted with a vinylsilane in the presence of a free radical initiator. When a silane-containing polyethylene is used, it may also be desirable to include a crosslinking catalyst in the formulation (such as dibutyltindilaurate or dodecylbenzenesulfonic acid) or another Lewis or Bronsted acid or base catalyst.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the copolymer and is preferably in the range of 15 to 40 percent by weight.

A third comonomer can be included, e.g., another alpha-olefin or a diene such as ethylidene norbornene, butadiene, 1,4-hexadiene, or a dicyclopentadiene. Ethylene/propylene copolymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a copolymer of ethylene and one or more alpha-olefins having 3 to 12 carbon atoms, and preferably 3 to 8 carbon atoms. The melt index can be in the range of 1 to 20 grams per 10 minutes, and is preferably in the range of 3 to 8 grams per 10 minutes.

Any polypropylene may be used in these compositions. Examples include homopolymers of propylene, copolymers of propylene and other olefins, and terpolymers of propylene, ethylene, and dienes (e.g. norbornadiene and decadiene). Additionally, the polypropylenes may be dispersed or blended with other polymers such as EPR or EPDM. Examples of polypropylenes are described in POLYPROPYLENE HANDBOOK: POLYMERIZATION, CHARACTERIZATION, PROPERTIES, PROCESSING, APPLICATIONS 3-14, 113-176 (E. Moore, Jr. ed., 1996).

Suitable polypropylenes may be components of TPEs, TPOs and TPVs. Those polypropylene-containing TPEs, TPOs, and TPVs can be used in this application.

Suitable polyvinyl chloride polymers are selected from the group consisting of PVC homopolymers, PVC copolymers, polyvinyl dichlorides (PVDC), and polymers of vinylchloride with vinyl, acrylic and other co-monomers.

The nanographene should have an aspect ratio in the range of greater than or equal to about 100:1, preferably, greater than equal to about 1000:1. Furthermore, the nanographene should have a surface area greater than or equal to about 40 m²/gram nitrogen surface absorption area. Preferably, the surface area is greater than or equal to about 100 m²/gram nitrogen surface absorption area. Preferably, the nanographene is expanded.

There are several routes to graphene. One is to intercalate graphite while performing partial oxidation in mixed sulfuric/nitric acid. Another is to oxidize graphite with powerful oxidizing agents in concentrated acid. The oxidized graphite, graphite oxide or graphitic acid are then reduced to graphene by a chemical or thermal process or via a microwave-assisted heating process.

The polymer composition may further comprise other flame retardant fillers, such as metal hydrate fillers, phosphate compounds, and other flame-retardant additives. Suitable flame retardants include metal hydroxides and phosphates. Preferably, suitable metal hydroxide compounds include aluminum trihydroxide (also known as ATH or aluminum trihydrate) and magnesium hydroxide (also known as magnesium dihydroxide). Other flame-retarding metal hydroxides are known to persons of ordinary skill in the art. The use of those metal hydroxides is considered within the scope of the present invention.

The surface of the metal hydroxide may be coated with one or more materials, including silanes, titanates, zirconates, carboxylic acids, and maleic anhydride-grafted polymers. Suitable coatings include those disclosed in U.S. Pat. No. 6,500,882. The average particle size may range from less than 0.1 micrometers to 50 micrometers. In some cases, it may be desirable to use a metal hydroxide having a nano-scale particle size. The metal hydroxide may be naturally occurring or synthetic.

Preferred phosphates include ethylene diamine phosphate, melamine phosphate, melamine pyrophosphate, melamine polyphosphate, and ammonium polyphosphate.

Other suitable non-halogenated flame retardant additives include red phosphorus, silica, alumina, titanium oxides, carbon nanotubes, talc, clay, organo-modified clay, silicone polymer, calcium carbonate, zinc borate, antimony trioxide, wollastonite, mica, hindered amine stabilizers, ammonium octamolybdate, melamine octamolybdate, frits, hollow glass microspheres, intumescent compounds, and expandable graphite. Preferably, silicone polymer is an additional flame retardant additive.

Suitable halogenated flame retardant additives include decabromodiphenyl oxide, decabromodiphenyl ethane, ethylene-bis (tetrabromophthalimide), and dechlorane plus.

### EXAMPLES

In order to investigate the effect of nano-dispersed expanded graphene in flame retardant application, a commercially-available jacket formulation was selected because it is based on the linear low density polyethylene (LLDPE) as a polymer major matrix, which provides a good balance of physical properties and low density in comparison to PVC jacket compounds. The expanded graphene was added to make a master batch with LLDPE, which was letdown to the jacket formulation at 8 weight percent of the expanded graphene in a Brabender mixer at 180 degrees Celsius and 30 rpm. A control of the commercial sample, containing 15 weight percent of Ketjen black, was used

Both exemplified compositions contained 0.70 weight percent of Agerite MA polymerized 1,2-dihydro-2,2,4-trimethylquinoline antioxidant and 0.15 weight percent MB 1000 polymer processing aid. DFH2065 is a 0.7 melt index linear low density polyethylene, having a density of 0.918 g/cm³. The graphene was prepared using 20 weight percent of GrafTech GT120 in DFH2065 master batch. DFNA-1477 NT is a 0.9 melt index very low density polyethylene, having a density of 0.905 g/cm³.

| Component | | Comparative |
|---|---|---|
| (weight %) | Example 1 | Example 2 |
| DFH 2065 | 26.55 | 54.15 |
| DFNA-1477 NT | 32.50 | 30.00 |
| Graphene masterbatch | 40.00 | 0.00 |
| Ketjen black | 0.00 | 15.00 |

### Flame Retardant Tests

Oxygen index test (ASTM D2863) is a method to determine the minimum concentration of oxygen in an oxygen/nitrogen mixture that will support a flaming burn in a plastic specimen. The oxygen index test samples are molded as 125 mil thickness plaques. The dimension of the sample is 70 mm in length and 5 mm in width. The test sample is positioned vertically in a glass chimney, and an oxygen/nitrogen environment is established with a flow from the bottom of the chimney. The top edge of the test sample is ignited, and the oxygen concentration in the flow is decreased until the flame is no longer supported. Oxygen Index, in percent, is calculated from the final oxygen concentrations tested.

The oxygen index flammability test was performed at room temperature to measure precise relative flammability of DHDA7708 with GT120 and DHDA7708 with Ketjen black. The oxygen index of DHDA7708 with GT120 was 25 while that of DHDA7708 with Ketjen black was 23. Although the DHDA7708 formulation with GT120 contains only 8 weight percent of the filler, it resulted in higher oxygen index than DHDA7708 with Ketjen black contain 15 weight percent of the carbon black.

The key noticeable burning behavior of DHDA7708 with GT120 was that it appeared to inhibit the flame propagation after ignition at the oxygen index range near 25˜28. However, the DHDA7708 with Ketjen black ignited and exhibited a candle-like burning behavior with high burning velocity in vertically downward. After the oxygen index test, the DHDA-7708 with GT120 maintained its shape by forming chars while DHDA7708 with Ketjen burned off with a minimal residue.

The test criteria for Underwriters Laboratory 94 HB (horizontal burn) test is slow horizontal burning on a 3 mm thick specimen with a burning rate is less than 3 inch/min or stops burning before the 5 inch mark. H-B rated materials are considered “self-extinguishing”. The test uses a 0.5″×5″ specimen with the thickness of 125 mil held at one end in a horizontal position with marks at 1″ and 5″ from the free end. A flame is applied to the free end for 30 seconds or until the flame front reaches the 1″ mark. If combustion continues, the duration is timed between the 1″ mark and the 5″ mark. If combustion stops before the 5″ mark, the time of combustion and the damaged length between the two marks are recorded. A material will be classified UL 94 HB if it has a burning rate of less than 3″ per minute or stops burning before the 5″ mark.

The DHDA7708 with Ketjen was ignited and continued to burn in slow horizontal burning on a 125 mil thickness specimen so that it failed for the UL 94 H-B rating. However, DHDA7708 with GT120 did not ignite under the UL 94 H-B condition and passed the UL 94 H-B rating.

Cone Calorimeter test: Using a truncated conical heater element to irradiate test specimens at heat fluxes from 10-100 kW/m², the Cone Calorimeter measures heat release rates and provides detailed information about ignition behavior, mass loss, and generation of smoke during sustained combustion of the test specimen.

The heat flux in the Cone calorimeter test was 35 kW/m². DHDA-7708 with GT120 resulted in slightly expanded homogeneous foamy char structure in comparison to DHDA7708 with Ketjen black, which almost completely lost its mass.

The Cone Calorimeter test showed positive evidences for the flame retardant mechanism of DHDA7708 with GT120, which worked by slower time to ignite, and lower smoke released, lower specific mass loss rate, and lower average heat release rate in comparison to DHDA7708 with Ketjen black as shown in Table 2. The ratio of average peak heat release rate and ignition time is believed to account for approximately the heat release occurring from surfaces over which flame is spreading. The data suggest that DHDA7708 with GT120 reduces the heat release occurring from surfaces over which flame is spreading.

The peak heat release rate was higher for DHDA-7708 with GT120 than DHDA7708 with Ketjen black.

TABLE 2
Calorimetric characteristics

| Property | Example 1 | Comp. Ex. 2 |
|---|---|---|
| Time to Ignition, Seconds | 186 | 121 |
| Total Smoke Released, m²/m² | 1134.6 | 1414.7 |
| Average Specific Mass Loss Rate, g/(m² sec) | 3.37 | 3.81 |
| Average Heat Release Rate, kW/m² | 129.51 | 145.29 |
| Peak Heat Release Rate, kW/m² | 474.77 | 365.23 |
| Peak Heat Release Rate/Time to Ignition | 2.55 | 3.02 |
| Average Effective Heat of Combustion, MJ/kg | 38.25 | 38.87 |
| Average Mass Loss Rate, g/sec | 0.034 | 0.038 |

What is claimed is:

1. A flame retardant composition comprising:
a. an organic polymer selected from the group consisting of polyolefins and polyvinyl chloride and
b. a nanographene.

2. The flame retardant composition of claim 1 wherein the organic polymer is a polyolefin polymer selected from the group consisting of ethylene polymers and propylene polymers.

3. The flame retardant composition of claim 1 wherein the organic polymer is a polyvinyl chloride selected from the group consisting of PVC homopolymers, PVC copolymers, polyvinyl dichlorides (PVDC), and polymers of vinylchloride with vinyl, acrylic and other co-monomers.

4. The flame retardant composition of claim 2 or claim 3 wherein the nanographene has an aspect ratio of greater than or equal to 100:1.

5. The flame retardant composition of any of claims 2-4 wherein the nanographene has a surface area greater than or equal to 40 m²/gram nitrogen surface absorption area.

6. The flame retardant composition of any of claims 2-5 wherein the nanographene is expanded.
